(19) United States
(12) Patent Application Publication
(10) Pub. No.: US 2017/0368731 A1
(43) Pub. Date: Dec. 28, 2017

(54) EXTRUSION AGENT FOR POLYOLEFINS EXTRUDABLE IN THE FORM OF FIBRES

(71) Applicant: Arkema France, Colombes (FR)

(72) Inventors: Samuel Devisme, Rouen (FR); Jéôme CHAUVEAU, Mesnil en Ouche (FR); François BEAUME, Saint Genis Laval (FR); James T. GOLDBACH, Paoli, PA (US); David A. SEILER, Garnet Valley, PA (US)

(21) Appl. No.: 15/538,951

(22) PCT Filed: Dec. 10, 2015
(86) PCT No.: PCT/FR2015/053405

§ 371 Date: Jun. 22, 2017

(30) Foreign Application Priority Data
Dec. 22, 2014 (FR) 1463123

(51) Int. Cl. B29C 47/00; C08F 214/22; D01F 6/46; D01F 1/02; B29K 25/00

(52) U.S. Cl. CPC B29C 47/0014; D01F 6/46; D01F 1/02; B29C 47/0004; C08F 214/222; B29C 2947/922; B29K 2025/00

(57) ABSTRACT

The invention relates to an extrusion-assisting agent containing low-viscosity thermoplastic fluorinated polymers and preferably not containing a synergist. The invention also relates to the use of the extrusion agent for extrusion in the form of monofilament or multifilament fibres or non-woven materials, and to the extrusion method.

### FIELD OF THE INVENTION

The present invention generally relates to the domain of extrusion of thermoplastic polymers. More particularly, the invention relates to an extrusion-assisting agent, i.e. an additive that reduces or eliminates surface defects that appear when a thermoplastic resin, specifically a polyolefin, is extruded in the form of fibers. The extrusion-assisting agent according to the invention (or extrusion agent in the rest of the application) contains low-viscosity thermoplastic fluorinated polymers and does not contain a synergist. The invention also relates to the use of the extrusion agent to extrude in the form of mono- or multifilament fibers or non-wovens, and to an extrusion method.

### TECHNICAL BACKGROUND

During polyolefin extrusion, irregularities in flow and/or deposits may appear as it exits the die, which causes surface defects and sometimes altered mechanical properties in the extruded polyolefin. Adding an extrusion agent to the polyolefin to be extruded can reduce these defects or even eliminate them.

Document U.S. Pat. No. 4,013,622 describes the use of polyoxyethylene glycol (PEG) as an extrusion agent.

It is known to use fluorinated polymers as extrusion agents, as described in documents U.S. Pat. No. 3,125,547 and U.S. Pat. No. 4,581,406, which disclose the use of fluoro-elastomers.

Many documents describe the use of extrusion agents comprising fluorinated polymers mixed with synergists, and optionally other additives. The Applicant has already described in document EP 1616907 the use of a mixture of at least one fluorinated polymer and at least one interface agent, as extrusion agent to extrude a polyolefin in film form.

Documents U.S. Pat. No. 4,855,360 and U.S. Pat. No. 5,587,429 disclose the use of a fluoro-elastomer in

combination with a polyoxyalkylene to improve the transformation of hydrocarbon polymers.

However it was observed that using fluoro-elastomers as extrusion agent does not manage to eliminate the extrusion defects in all types of polyolefins, in particular low-viscosity polyolefins, having a fluidity index of at least 10 g/10 min, preferably greater than 25 g/10 min. Indeed in this case using fluoro-elastomers as extrusion agent does not give satisfactory results to eliminate or at least reduce surface defects, because these compounds do not disperse evenly in the mass of said polyolefin,

Therefore there is a need to prepare new extrusion agents containing fluorinated polymers that improve the extrusion of low-viscosity polyolefins, in particular in the form of fibers.

### SUMMARY OF THE INVENTION

The invention first relates to an extrusion agent for extrudable polyolefins in the form of fibers, said extrusion agent comprising a polymer containing vinylidene fluoride (a polymer called “PVDF” hereinbelow) that has thermoplastic character.

In a characteristic manner, said PVDF has viscosity less than 5 kP, preferably less than 1 kP, as measured at 232° C. and 100 s⁻¹ using a capillary or a parallel-plate rheometer. The PVDF according to the invention has a molecular mass ranging from 5,000 to 200,000 Dalton, as measured by steric exclusion chromatography.

Advantageously, the extrusion agent according to the invention is free of synergist. The term “synergist” is understood here to mean an interface agent (surfactant) that is a thermoplastic oligomer or polymer that is liquid or molten at the extrusion temperature and has a lower melt viscosity than that of the polymer being extruded and the additives used. Many synergists are used in combination with a fluorinated polymer to strengthen its positive effects during polyolefin extrusion.

It has now been found that the extrusion agent according to the invention produces good results during polyolefin extrusion, such as lower pressure, improved surface state and lack of deposits. The extrusion agent according to the invention is particularly effective to reduce or eliminate the extrusion defects that can appear during the extrusion of low-viscosity polyolefins, having a fluidity index of at least 10 g/10 min, preferably greater than 25 g/10 min, advantageously greater than 40 g/10 min, measured according to standard ASTM 1238.

According to a second feature, the invention relates to fibers extruded from a formulation comprising a polyolefin and the extrusion agent of the invention. These fibers are presented in the form of mono- or multifilaments, or in the form of non-woven materials. One of the advantages provided by the extrusion agent according to the invention is to allow production of good quality fibers from low-viscosity polyolefins, for which the use of a fluoro-elastomer as extrusion agent (alone or in mixtures with a synergist), does not give satisfactory results, because of its high viscosity and elasticity, which prevents even dispersion in the polyolefin mass.

According to another feature, the invention relates to a method for manufacturing fibers by extrusion of a polyolefin using the extrusion agent of the invention, said polyolefin having a fluidity index of at least 10 g/10 min, preferably greater than 25 g/10 min, advantageously greater than 40 g/10 min, said method comprising the following steps:
a. adding said extrusion agent to the polyolefin formulation, and
b. extruding the final polyolefin formulation in the form of fibers.

### DESCRIPTION OF EMBODIMENTS OF THE INVENTION

The invention is now described in greater detail and in a nonlimiting manner in the description which follows.

According to a first feature, the invention relates to an extrusion agent for extrudable polyolefins in the form of fibers, said extrusion agent comprising a polymer containing vinylidene fluoride (PVDF) having viscosity less than 5 kP, preferably less than 1 kP, and having thermoplastic character.

According to one embodiment, said polymer is a PVDF homopolymer.

According to another embodiment, the PVDF is a copolymer of VDF fluoride and at least one other comonomer chosen from chlorotrifluoroethylene (CTFE), hexafluoropropylene (HFP), trifluoroethylene (VF3), tetrafluoroethylene (TFE) and ethylene, Advantageously, said copolymer contains at least 75% by weight of VDF, preferably at least 85% by weight of VDF, which gives it a thermoplastic character.

These polymers may be obtained by polymerization methods known as polymerization in solution, in emulsion or in suspension. According to one embodiment, the PVDF is prepared by an emulsion method in the absence of fluorinated surfactant.

The PVDFs according to the invention are characterized by low viscosity when melted, i.e. viscosity ranging from 0.01 to less than 5 kP, preferably from 0.03 to 2.5 kP, advantageously from 0.05 to less than 1 kP, and more preferentially from 0.1 to 0.8 kP, Viscosity is measured at 232° C., at a shear gradient of 100 s⁻¹ using a capillary rheometer or a parallel-plate rheometer, according to standard ASTM D3825. The two methods give similar results.

These PVDFs have number average molecular masses ranging from 5 kDa to 200 kDa, preferably from 10 kDa to 100 kDa, as measured by steric exclusion chromatography in 0.003 M DMF/LiBr with PMMA as calibration standard. These low-molecular weight PVDFs may be obtained using high levels of one or more chain transfer agents. According to one embodiment, chain transfer agents suitable for this purpose are chosen from:
short-chain hydrocarbons, such as ethane and propane,
esters, such as ethyl acetate and diethyl maleate,
alcohols, carbonates, ketones,
halocarbons and hydrohalocarbons, such as chlorocarbons, hydrochlorocarbons, chlorofluorocarbons and hydrochlorofluorocarbons,
organic solvents, when they are added to the polymerization reaction as an emulsion or in suspension.

Other factors that boost production of low-molecular weight polymers are conducting the polymerization reaction at high temperatures, or using high levels of initiator.

The PVDFs that constitute the extrusion agent according to the invention are preferably homogeneous copolymers, where this term means that they have uniform chain structures wherein the statistical distribution of the comonomer(s) along the polymer chain is narrow.

This particular comonomer distribution distinguishes these polymers (called “homogeneous”) from those called “heterogeneous” that are characterized by the fact that the polymer chains have an average comonomer distribution that is multimodal or broad; heterogeneous PVDF therefore comprises polymer chains rich in comonomer and chains comprising little or no comonomer. The Applicant has described heterogeneous PVDF and extrusion agents containing them in document EP 1976927.

Homogeneous PVDF copolymers are prepared by a single-step method, in which the VDF and the comonomer are progressively injected, keeping a constant VDF/comonomer mass ratio.

One or more additives may be added to the PVDF described above to form the extrusion agent according to the invention. These additives are advantageously chosen from primary antioxidants like phenols or hindered phenols, and/or secondary antioxidants chosen from phosphor-containing compounds (phosphonites and/or phosphites). Amines may also be used but in general their use must be limited due to possible interactions with the PVDF.

According to a second feature, the invention relates to fibers extruded from a formulation comprising a polyolefin and the extrusion agent of the invention. These fibers are presented in the form of mono- or multifilaments, or in the form of non-woven materials that are groups of fibers oriented randomly or directionally and presented in the form of a cloth, a layer or a mat of fibers. The diameters of these fibers range from 0.1 to 300 microns, advantageously from 0.5 to 5 microns (for non-wovens), from 5 to 50 microns (for multifilament fibers), from 50 to 300microns (for monofilament fibers). These diameters are given for indication. These fibers are used in many domains such as textiles (clothing, architecture, industrial) and filtration (air, liquids such as water and fuels).

According to another feature, the invention relates to a method for manufacturing fibers by extrusion of a polyolefin using the extrusion agent of die invention, said polyolefin having a fluidity index of at least 10 g/10 min, preferably greater than 25 g/10 min, advantageously greater than 40 g/10 min, said method comprising the following steps:
a. adding said extrusion agent to the polyolefin formulation, and
b. extruding the final polyolefin formulation in the form of fibers.

The extrusion agent may be added to the final formulation in a prior compounding phase or as a dry mixture during extrusion by using a master-batch. In this latter case, the extrusion agent is diluted in a polyolefin formulation having the same viscosity as the polyolefin formulation to be extruded.

The extrudable thermoplastic resin in the form of fibers may be a polyolefin, a styrene resin, a polyester or a polyamide/copolyamide.

The polyolefin is chosen from:
a polyethylene, in particular a low density polyethylene (LDPE), a high density polyethylene (HDPE), a low density linear polyethylene (LLDPE), an ultra-high density polyethylene (UHDPE).
a polypropylene, in particular an iso- or syndiotactic polypropylene;

It would not be outside the scope of the invention to have an extrusion of a mixture charged with two or more polyolefins.

Styrene resin is denoted as a homopolystyrene or a styrene copolymer including at least 50% by weight of styrene. This may be a crystal polystyrene, a shock polystyrene, an acrylonitrile-butadiene-styrene (ABS) copolymer or a sequenced copolymer, for example a copolymer comprising styrene and a diene.

The polyester may for example be poly(ethylene terephthalate) (PET) or poly(butylene terephthalate) (PBT).

The polyamide and copolyamide may for example be a PA6, PA6.6, PA6.6/6, PA6.10, PA 12, PA10.10, PA11, where this list is not restrictive.

The thermoplastic resin may be charged i.e. contain dispersed organic or inorganic particles. The inorganic filler may for example be a silica, an alumina, a zeolite, a titanium oxide, sodium or potassium carbonate, hydrotalcite, talc, a zinc oxide, a magnesium or calcium oxide, a diatomaceous earth or carbon black. It may also be an inorganic pigment. Organic particles may for example be an organic pigment or an antioxidant. The organic filler may be antioxidants, but also UV absorbers, HALS, slip agents, anti-block agents, anti-fogging or water-repellent agents.

In a specific case, the polyolefin is a polypropylene having a fluidity index of at least 10 g/10 min, preferably greater than 25 g/10 min, advantageously greater than 40 g/10 min, measured according to standard ASTM 1238.

### EXAMPLES

The following examples illustrate the invention without limiting it.

### Example 1

A high pressure autoclave having an internal volume of 2 L is charged with 1000 mL of deionized water and 0.6 g of surfactant Pluronic® 31R1, The autoclave is purged with nitrogen with fast stirring for 20 min, The aeration valve is closed, 5.0 g of propane is added, and it is heated to 83° C. Next about 140 g of vinylidene fluoride (VDF) is added to reach a pressure of 44.8 bar. While continuing to stir the autoclave contents, 1% by weight of a potassium persulfate solution and 1% by weight of a sodium acetate solution (total solids content 2% by weight) are added at a flow rate of 3.0 mL/min until the pressure begins to fall, when the flow rate is reduced to 0.5 mL/min. VDF is added continuously, maintaining the pressure at 44.8 bar. When the quantity of VDF added is 400 g, the VDF and initiator feed is stopped and the reaction is maintained at 83° C. until the pressure falls below 20.68 bar; at this stage the autoclave is ventilated and cooled to ambient temperature. 1.3 L of fluid white latex is obtained. The latex is dried at 110° C. for 12 h in an oven to obtain dry fragments. The latex has the following characteristics:
particle size: 276 nm;
solids content: 30.2% by weight;
fluidity index: 0.4 kP (232° C., 100 s⁻);
weight-average molecular weight: 105.7 kDa. as measured by steric exclusion chromatography in DMF/LiBr 0.02 M with PMMA as calibration standard, number-average molecular weight: 52.7 kDa;
melting temperature: 170.7° C., measured by differential scanning calorimetry (DSC) second heating cycle.

### Examples 5-6

### PVDF Homopolymers

A high pressure autoclave having an internal volume of 352.4 L is charged with 149.3 L of deionized wafer and 720 g of fluorinated surfactant Capstone® FS-10 (solution at 30% by weight). The autoclave is purged with nitrogen; the aeration valve is closed, ethyl acetate (CTA) is added, and it is heated to 83° C. Next vinylidene fluoride (VDF) is added to reach a pressure of 44.8 bar. While continuing to stir the autoclave contents, 3.629 kg of a first solution of 1.65% by weight potassium persulfate and a second solution of 1.65% by weight sodium acetate are added quickly (total solids contents: 3.3%). Following a short induction phase, the solution of initiator is added continuously at a flow rate of 0.227 to 1.361 kg/h. VDF is added continuously, maintaining the pressure at 44.8 bar. When the quantity of VDF added is 96.162 kg, the VDF and initiator feed is stopped and the reaction is maintained at 83° C. until the pressure falls below 20.68 bar; at this stage the autoclave is ventilated and cooled to ambient temperature. About 272.156 kg of fluid white latex is obtained, The latex is diluted to 20% by weight and dried by atomization. The latex has the following characteristics shown in Table 1:
particle size: about 300 nm;
solids content by weight: 30%;
fluidity index: measured at 232° C., 100 s⁻¹ using a capillary rheometer or a parallel-plate rheometer;
melting temperature: measured by differential scanning calorimetry (DSC) second heating cycle.

### Examples 7 and 8

### VDF/HFP Copolymers

A high pressure autoclave having an internal volume of 352.4 L is charged with 156.49 L of deionized water and 66 g of surfactant Pluronic® 31R1. The autoclave is purged with nitrogen; the aeration valve is closed, ethyl acetate is added and it is heated to 83° C. While continuing to stir the autoclave contents, 8.3 kg of hexafluoropropylene (HFP) and YDF are added to reach a pressure of 44.8 bar. While continuing to stir the autoclave contents, 2.95 kg of a first solution of 1% by weight potassium persulfate and a second solution of 1% by weight sodium acetate are added quickly (total solids contents: 2%). Following a short induction phase, the solution of initiator is added continuously at a flow rate of 0.227 to 1.361 kg/h. HFP and VDF are added continuously, maintaining the pressure at 44.8 bar. When the quantity of YDF added is 7.484 kg and the HFP quantity is 2.042 kg (9.526 kg in total) VDF, HFP and initiator feed is stopped and the reaction is maintained at 83° C. until the pressure falls below 20.68 bar; at this stage the autoclave is ventilated and cooled to ambient temperature. About 24.95 kg of fluid white latex is obtained (its solids content is 33%), The latex is diluted to 20% by weight and dried by atomization to obtain a white powder.

Its characteristics are presented in Table 1 (“n/d” means “not determined”.

The copolymer's HFP mass content was determined by magnetic resonance spectroscopy (¹⁹F NMR).

TABLE 1

| | | Fluidity | Melt | | |
|---|---|---|---|---|---|
| | CTA filler | index | rheology | | |
| | g CTA/kg | kP, @ | (kP, @ | | % by |
| | VDF or/kg | 100 s⁻¹, | 100 s⁻¹, | | weight of |
| | (VDF + | 230° C., | 230° C., | m.p. | HFP in the |
| E.g. | HFP) | capillary | parallel plates) | (° C.) | copolymer |
| 2 | 23.6 | 1.2 | 1.2 | 170.6 | — |
| 3 | 28.3 | 0.7 | 0.62 | 171.4 | — |
| 4 | 35.4 | 0.4 | 0.25 | 171.4 | — |
| 5 | 47.2 | 0.1 | 0.11 | 171.8 | — |
| 6 | 76.0 | <0.1 | 0.04 | 172.4 | — |
| 7 | 12.4 | 4.0 | n/d | 123.9 | 17.4 |
| 8 | 15.7 | 1.7 | n/d | 123.9 | 17.6 |

### Example 9

Granules of a PVDF homopolymer with average viscosity: 3-4 kP are incorporated by twin-screw extrusion at 5% by mass in a polypropylene like Sabic® PP 511 A, with MFI25 g/10 min under 230° C., 2.16 kg. This master-batch, which is in the form of granules, is then tested as an extrusion-assisting agent according to the protocol described below:
extrusion at 230° C. on a Collin extruder with screw diameter 30 mm, L/D= 25 with a capillary die 0.5 mm in diameter and 10 mm long;
after 15 minutes of extrusion said master-batch is added at 1% by mass.
   90 minutes after adding the master-batch, a pressure drop of about 10 bar and improved surface appearance are observed.

### Example 10

Granules of homogeneous VDF/HFP copolymer (HFP mass content: 18-20%, average viscosity: 0.4-0.5 kP) are incorporated by twin-screw extrusion at 5% by mass in a polypropylene like Sabic® PP 511 A, with MFI 25 g/10 min under 230° C., 2.16 kg. This master-batch, which is in the form of granules, is then tested as an extrusion-assisting agent according to the protocol described below:
extrusion at 230° C. on a Collin extruder with screw diameter 30 mm, L/D=25 with a capillary die 0.5 mm in diameter and 10 mm long;
after 15 minutes of extrusion said master-batch is added at 1% by mass.
   90 minutes after adding the master-batch, a pressure drop of about 20 bar and improved surface appearance are observed.

### Example 11

Granules of PVDF from synthesis example 5 (viscosity about 0.11 kP) are incorporated by twin-screw extrusion at 5% by mass in a polypropylene like Sabic® PP 511 A, with MFI 25 g/10 min under 230° C., 2.16 kg. This master-batch, which is in the form of granules, is then tested as an extrusion-assisting agent according to the protocol described below:
extrusion at 230° C. on a Collin extruder with screw diameter 30 mm, L/D= 25 with a capillary die 0.5 mm in diameter and 10 mm long;
after 15 minutes of extrusion said master-batch is added at 1% by mass.
   90 minutes after adding the master-batch, a pressure drop of about 15 bar and improved surface appearance are observed.

1. An extrusion agent for an extrudable polyolefin in the form of fibers, said extrusion agent comprising a vinylidene fluoride polymer (PVDF) having viscosity less than 5 kP, a molecular mass ranging from 5 to 200 kDa measured by steric exclusion chromatography, and with thermoplastic character, the viscosity being measured at 232° C., at a shear gradient of 100 s⁻¹ according to standard ASTM D3825.

2. The extrusion agent as claimed in claim 1, wherein said PVDF is a PVDF homopolymer.

3. The extrusion agent as claimed in claim 1, wherein said PVDF is a copolymer comprising vinylidene fluoride (VDF) and at least one other comonomer chosen from chlorotrifluoroethylene (CTFE), hexafluoropropylene (HFP), trifluoroethylene (VF3), tetrafluoroethylene (TFE) and ethylene, said copolymer containing at least 75% by weight of VDF.

4. The extrusion agent as claimed in claim 1, wherein said PVDF has viscosity of less than 1 kP.

5. The extrusion agent as claimed in claim 1, wherein said PVDF has a molecular mass ranging from 10 to 100 kDa measured by steric exclusion chromatography.

6. The extrusion agent as claimed in claim 1 wherein said PVDF is a homogeneous copolymer.

7. The extrusion agent as claimed in claim 1 for the extrusion of a polyolefin having a fluidity index of at least 10 g/10 min when it is measured at 230° C. and 2.16 kg (Standard ASTM 1238).

8. The extrusion agent as claimed in claim 7, wherein said polyolefin is a polypropylene.

9. The extrusion agent as claimed in claim 1, wherein said extrusion agent is free of synergist.

10. The extrusion agent as claimed in claim 1, further comprising an additive chosen from one or more antioxidants.

11. Fibers extruded from a formulation comprising a polyolefin and an extrusion agent as claimed claim 1.

12. The fibers as claimed in claim 11 wherein said polyolefin has a fluidity index of at least 10 g/10 min, preferably greater than 25 g/10 min, advantageously greater than 40 g/10 min.

13. The fibers as claimed in claim 11, said fibers being mono- or multi-filaments.

14. The fibers as claimed in claim 11, said fibers being presented in the form of oriented groups of fibers, to form non-woven materials.

15. A method for extruding a polyolefin in the form of fibers, using an extrusion agent as claimed in claim 1, said polyolefin having a fluidity index of at least 10 g/10 min, said method comprising the following steps:
a. adding said extrusion agent to the polyolefin formulation, and
b. extruding the final polyolefin formulation in the form of fibers.

16. The method as claimed in claim 15, wherein in step a) comprises: adding by compounding said extrusion agent to the polyolefin formulation.

17. The method as claimed in claim 15, wherein in step a) said extrusion agent is first diluted in a polyolefin formulation having the same viscosity as the polyolefin formulation to be extruded, to form a master-batch that is added, secondly, to said polyolefin formulation.

18. The extrusion agent as claimed in claim 7 for the extrusion of a polyolefin having a fluidity index of greater than 25 g/10 min, when it is measured at 230° C. and 2.16 kg (Standard ASTM 1238).

19. The extrusion agent as claimed in claim 18 for the extrusion of a polyolefin having a fluidity index of greater than 40 g/10 min, when it is measured at 230° C. and 2.16 kg (Standard ASTM 1238).
